(19) United States
(12) Patent Application Publication
(10) Pub. No.: US 2023/0150058 A1
(43) Pub. Date: May 18, 2023

(54) APPARATUS AND METHOD FOR HARDENING A TRANSPARENT MATERIAL

(71) Applicant: TRUMPF Laser- und Systemtechnik GmbH, Ditzingen (DE)

(72) Inventors: Felix Zimmermann, Ditzingen (DE); Marcel Schaefer, Burladingen (DE)

(21) Appl. No.: 18/157,090

(22) Filed: Jan. 20, 2023

Related U.S. Application Data
(63) Continuation of application No. PCT/EP2021/070092, filed on Jul. 19, 2021.

(30) Foreign Application Priority Data
Jul. 22, 2020 (DE) 10 2020 119 306.8

(51) Int. Cl. B23K 26/0622; B23K 26/046; B23K 26/00; B23K 26/06; B23K 26/082

(52) U.S. Cl. CPC B23K 26/0624; B23K 26/046; B23K 26/0006; B23K 26/0643; B23K 26/082; B23K 2103/54

(57) ABSTRACT

A method for hardening a transparent material includes the steps of introducing a material modification to the transparent material using a laser beam of ultrashort laser pulses of an ultrashort pulse laser so as to harden at least a portion of the transparent material.

### CROSS-REFERENCE TO PRIOR APPLICATION

This application is a continuation of International Application No. PCT/EP2021/070092 (WO 2022/018006 A1), filed on Jul. 19, 2021, and claims benefit to German Patent Application No. DE 102020119306.8, filed on Jul. 22, 2020. The aforementioned applications are hereby incorporated by reference herein.

### FIELD

The invention relates to an apparatus and to a method for hardening a transparent material, in particular for the localized hardening of the surface of a transparent material.

### BACKGROUND

It is known that the hardening of glass, for example for use in consumer electronics such as smartphones, smartwatches or tablets, represents a particular challenge. The aim is hardening the material in order to render the respective display glasses significantly more resistant to scratches and impacts than untreated glasses.

However, until now, there have only been methods that permit global hardening of the material for displays and therefore in particular do not enable local hardening for example in regions that are under considerable stress. For example, foldable displays are exposed to considerable loads at the respective bending point. Displays having rounded sides for frameless displays are also exposed to particular loads at the bending points due to the curved shape.

### SUMMARY

In an embodiment, the present disclosure provides a method for hardening a transparent material includes the steps of introducing a material modification to the transparent material using a laser beam of ultrashort laser pulses of an ultrashort pulse laser so as to harden at least a portion of the transparent material

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1A, B show a schematic illustration of the beam geometry;

FIGS. 2A, B show a schematic illustration of the hardening method;

FIGS. 3A, B, C show a further schematic illustration of the hardening method;

FIGS. 4A, B, C, D show a schematic illustration for locally, regionally and globally hardening the material;

FIG. 5 shows various beam profiles; and

FIG. 6 shows a setup for beam splitting and for carrying out the method.

### DETAILED DESCRIPTION

Proceeding from the known prior art, an aspect of the present invention is to provide an improved method for hardening a transparent material, in particular for locally hardening the surface of the transparent material, and a corresponding apparatus for carrying out the method.

Accordingly, a method for hardening a transparent material, in particular for locally hardening the surface of the transparent material, is proposed. According to the invention, a material modification is introduced into or applied to the transparent material, preferably introduced or applied locally, by means of a laser beam of ultrashort laser pulses of an ultrashort pulse laser in order to harden the transparent material, preferably to harden it locally.

The ultrashort pulse laser in this case makes the ultrashort laser pulses available. An ultrashort pulse laser makes laser pulses in the picosecond range or femtosecond range available.

The laser can also make pulse trains, also known as bursts, of ultrashort laser pulses available, wherein each burst comprises the emission of a plurality of laser pulses. In particular, what are known as GHz bursts may also be provided, wherein the repetition rate of the individual laser pulses is for example in the order of up to 1000 GHz.

The transparent material is here substantially transparent to the wavelength of the laser light emitted by the ultrashort pulse laser. Substantially transparent means in this case that more than 50%, for example more than 90% or 95.5%, of the laser power incident on the material is transmitted through the material. Typically, a small portion of the laser energy that is not transmitted is also absorbed by the material. It is this absorbed laser energy that, provided the laser beam is highly focused, for example by means of an optical unit having a numerical aperture greater than 0.1, can result in strong local heating of the transparent material.

The extent of the region that is interacting with the laser beam, or of the region that is heated by the laser beam, is determined here by the beam geometry, for example by the focus diameter of the laser beam and the beam profile, see below.

A material modification is understood to mean a change in the transparent material that is permanent in the thermal equilibrium of the transparent material, for example the network structure of the material or the (local) density of the material, which is originally due to the local heating generated by the incoming direct laser radiation, and the subsequent cooling.

The material modification in or on the transparent material can here for example be a modification in the structure, in particular the crystalline structure and/or the amorphous structure and/or the chemical structure and/or the mechanical structure, of the transparent material. The material modification is provided in the material if it is introduced mainly into the volume of the material. By contrast, the material modification is provided on the material if the material modification mainly modifies the surface of the material. In particular, a material modification can, however, be introduced into or applied onto the material depending on the focus settings and the beam profile of the laser beam.

For example, a material modification introduced into an amorphous glass material can consist in the glass material receiving a crystalline structure component only in that region. The local heating and quick cooling can lead to a modification in the glass network structure, as a result of which the density and the hardness of the material change locally. For example, in the case of an amorphous glass material, a change in the network structure, for example due to a change in the bond angle and lengths or the network structure, can be achieved. In this way, a local change in the density and the hardness of the glass material in this region can be achieved.

A material modification can also be the direct change of a physical property, for example the strength and/or flexural strength and/or the tolerance of the material with respect to bending forces and shear forces and also shear and tensile stresses.

A material modification can also be a local change in density, which may depend on the selected material, in particular on the type of glass. For example, density variations in the material can cause stress and compression zones which have a higher material hardness than the untreated material.

A material modification can also occur, in particular, if the laser pulses, for example at least two successively introduced laser pulses, locally melt the material. The cooled melt can then comprise a material modification and have a higher or lower material hardness. Ultimately, the type of material modification depends on the material and the laser parameters, and the laser parameters can thus be set specific to the material.

If the temporal distance between successive ultrashort laser pulses is shorter than the thermal diffusion time of the material, this results in an accumulation of heat or an increase in temperature in the material, predominantly in the focus region of the laser. The temperature can then be (locally) increased with each of the successive pulses, for example until the melting temperature has been reached.

In order to melt the material in the joining region, for example between 2 and 10 ultrashort laser pulses and/or bursts can be introduced into the material. This plurality of ultrashort laser pulses and/or bursts are introduced for the intended material processing, viewed spatially, in each case in a laser spot, that is to say in the spatial extent of the respective focus region of the laser in the material. For a Gaussian laser beam, the laser spot is defined for example by twice the beam waist.

The number of the laser pulses introduced at a single location is referred to as a pulse overlap. The pulse overlap can be considered to be a measure of the accumulation of heat.

For example, if no feed motion takes place and all pulses are introduced at the same location of the material, pulse overlap is at its maximum. If, by contrast, a feed motion takes place between the material and the laser spot, the pulse overlap can decrease depending on the ratio of pulse frequency (repetition rate) and feed rate. If the feed rate is too high, no more overlap of the laser spots in the material occurs.

The number of ultrashort laser pulses and/or bursts per location in the material is given by the product of the laser spot size SG and the repetition rate P per feed rate VG. In other words, the pulse overlap is given for example by SG*P/VG.

A material modification can then be introduced by heating and subsequent rapid cooling. For example, the fictive temperature of the material and thus the network structure can be changed by cooling rates of the order of magnitude of 10⁶ kelvin per second, with the result that a material modification with a locally increased or decreased hardness is formed due to the high cooling rate.

Introducing the material modifications is limited substantially to the region of action of the laser pulses of the laser beam, so that the transparent material is hardened locally. This means that hardening takes place in the immediate region of action of the laser pulses that are introduced.

In other words, local hardening is understood to mean that only a two-dimensional region or three-dimensional region of the transparent material is hardened selectively, but not all the material.

Accordingly, a material modification is introduced extensively or over the entire area only if laser pulses are introduced at all locations on the surface that is to be extensively processed, which can be achieved for example by scanning the full area of the surface that is to be extensively hardened.

In other words, a global or two-dimensional or regional hardening can take place by shifting for example the transparent material and the laser beam in relation to one another within the region to be hardened, with the result that material modifications can be introduced into different regions and localities of the material and local hardening accordingly takes place in these regions.

A distinction is drawn between the actual material modification and a material modification region which comprises the entire region in which the changed hardness due to the action of the laser pulses is measurable. This is in particular the region in which the material transitions, viewed spatially, starting from the material modification back into the initial state of the untreated regions of the glass material.

The transparent material can be a glass or a polymer or a ceramic or a pre-stressed variant of the materials just mentioned. For example, this can also include a thermally or chemically pre-stressed variant of the materials just mentioned, for example a thermally or chemically pre-stressed glass or pre-stressed plastic.

The laser beam used for the material processing can be a Gaussian or a quasi non-diffractive laser beam having a corresponding beam profile.

The beam profile of the laser beam can be described here by way of example by way of a longitudinal beam cross section along the propagation direction of the laser beam and by way of a lateral beam cross section perpendicular to the propagation direction of the laser beam.

A Gaussian beam profile means that the laser beam has both a Gaussian intensity distribution along its longitudinal beam cross section, that is to say along the propagation direction, and also a Gaussian intensity distribution along its lateral beam cross section, that is to say perpendicular to the propagation direction. Gaussian beams are typically provided by the natural fundamental modes of the laser, as a result of which the pulses of an ultrashort pulse laser can initially be utilized without any modification of the beam profile in principle.

The lateral focus zone d^{GF}₀ of a Gaussian beam, the Gauss focus, or the diameter of the Gaussian beam or of the Gaussian profile is defined by the second moments or the variance of the Gaussian curve. In addition, the longitudinal focus zone d^{GF}₀ is defined by the associated characteristic length, the Rayleigh length z_{R}=π(d^{GF}₀)²/4λ, as the distance starting from the focus position at which the beam cross section has increased by a factor of 2.

However, the laser beam can also be a quasi non-diffractive beam. Non-diffractive beams satisfy the Helmholtz equation:

∇²U(x,y,z)+k²U(x,y,z)=0

and have a clear separability into a transverse and a longitudinal dependence of the form

U(x,y,z)=Uₜ(x,y)exp(ik_{z}z)

Here, k=ω/c is the wave vector with its transverse and longitudinal components k²=k_{z}_{²}+kₜ_{²}, and Uₜ(x,y) is an arbitrary complex-valued amplitude function that is dependent only on the transverse coordinates x, y. The z-dependence in the beam propagation direction in U(x,y,z) leads to a pure phase modulation, and as a result the associated intensity I of the solution is propagation-invariant or non-diffractive:

I(x,y,z)=|U(x,y,z)|²=I(x,y,0).

This approach provides different classes of solutions in different coordinate systems, for example Mathieu beams in elliptic-cylindrical coordinates or Bessel beams in circular-cylindrical coordinates.

Experimentally it is possible to realize a multiplicity of non-diffractive beams in a good approximation, that is to say quasi non-diffractive beams. In contrast to the theoretical construct, these merely carry finite power. Just as finite is the length L of the propagation invariance of these quasi non-diffractive beams.

Furthermore, we define as transverse focus zone or diameter of the beam profile in quasi non-diffractive beams d^{ND}₀ the transverse dimensions of local intensity maxima as the shortest distance between directly adjoining, opposite intensity minima.

The longitudinal extent of the focus zone in the beam propagation direction of these almost propagation-invariant intensity maxima gives the characteristic length L of the quasi non-diffractive beam. That characteristic length is defined by way of the intensity drop to 50%, proceeding from the local intensity maximum in a positive and negative z-direction, that is to say in the propagation direction.

A quasi non-diffractive beam is present exactly if for d^{ND}₀≈d^{GF}₀, that is to say similar transverse dimensions, the characteristic length L clearly exceeds the Rayleigh length of the associated Gauss focus, for example if L>10z_{R}.

As a subset of the quasi non-diffractive beams, quasi Bessel beams or Bessel-type beams, here also referred to as Bessel beams, are known. The transverse field distribution Uₜ(x,y) in the vicinity of the optical axis here observes in a good approximation a Bessel function of the first kind of order n. A further subset of this class of beams is the Bessel-Gauss beams, which are widely used owing to the simple generation thereof. The illumination of an axicon in a refractive, diffractive or reflective embodiment with a collimated Gaussian beam enables the formation of the Bessel-Gauss beam. The associated transverse field distribution in the vicinity of the optical axis here observes in a good approximation a Bessel function of the first kind of the order 0, which is enveloped by a Gaussian distribution.

In this way, a significantly larger focal position tolerance can be achieved when processing the material. Consequently, for example, the influence of local undulations in the glass and the focal adjustment is reduced. It additionally makes it possible that the material can also be hardened or processed homogeneously over the layer thickness. Overall, by using quasi non-diffractive beams, the process reliability can be increased because the method is thereby tolerant with respect to possible error sources.

Typical Bessel-Gauss beams, which can be used for hardening, have for example diameters of the central intensity maximum on the optical axis of d^{ND}₀=2.5 μm. A Gauss focus with d^{ND}₀≈d^{GF}₀=2.5 μm by contrast is distinguished by a focus length in air of only z_{R}≈5 μm at λ=1 μm. In these cases which are relevant for material processing, L>>10z_{R} may even apply.

Preferably, the laser beam is focused by means of an optical unit and the focus region is arranged outside of the transparent material at a distance of less than 100 times, in particular less than 10 times, the characteristic length from the surface of the transparent material.

This has the advantage that, by controlling the focus and the pulse energy, the material can be hardened and also that the surface of the material can be changed. In particular, a nearly stress-free surface modification can be produced in this case.

The characteristic length can be understood to mean, in the case of Gauss-type beams, the Rayleigh length of the focused beam. The Rayleigh length is defined as the distance along the beam axis over which the beam cross-sectional area, starting from the beam cross-sectional area in the focus, or what is known as the beam waist, doubles. In particular, this can mean that the radius of the beam increases by the factor 2^{1/2}.

For example, the beam waist in the focus can be 1 μm. In that case, the beam cross-sectional area in the focus is approximately 3.14 μm². According to the characteristic length, here the Rayleigh length, the beam cross-sectional area is 6.28 μm², so twice as large. For Gauss-type beams, the characteristic length at a wavelength of 1 μm can be for example approximately 6 μm. For other beam shapes, different values for the characteristic length can be obtained.

The characteristic length can generally, that is to say in particular also in the case of Gauss-Bessel-type or Bessel-type beams, or differently shaped beams, also be understood to be the distance along the propagation direction—that is to say along the longitudinal beam cross section—after which the intensity of the beam, proceeding from the central intensity main maximum in the focus region, has halved.

The terms focus and focus region are used here synonymously, wherein the focus in the case of Gauss-type beams is clearly defined, whereas for Bessel-type beams and Gauss-Bessel-type beams a focus region is rather expanded in the longitudinal direction and is given by the intensity main maximum.

The distance of the focus region from the surface is given by the distance along the beam axis between the surface and the beam cross-sectional area in the focus region. In particular, the distance is thus independent of the angle of incidence of the laser beam onto the surface and finite extents of the beam cross-sectional area or surface roughnesses or curvatures.

The focus region and thus the intensity maximum of the laser beam can be located, as described above, completely above the surface and thereby outside of the transparent material. Consequently, an increasingly weak laser beam is introduced into the material from the surface in the beam direction, wherein the greatest part of the intensity of the laser beam is absorbed directly at the surface of the transparent material.

Due to the surface-near absorption of the laser light, the transparent material is modified and thereby hardened predominantly at the surface. The hardness at the surface is dominant in particular in comparison with the non-irradiated regions and with respect to the volume regions in the depth of the material in which absorption does not take place or takes place only to a reduced extent compared to the surface regions.

For example, the surface of the transparent material can be heated greatly due to the laser radiation, wherein the layers lying further below are heated less or only slightly. For example, material stress can build up in the slightly heated layers lying further below, for example because the density of the material changes due to the heating process. The modification of the material thickness, however, can be all the greater, the more the material is heated. In particular, the material density can be modified maximally at the surface. At the surface, the material can expand unimpeded, for example because here the transparent material has no resistance, for example due to a glass network structure or a material matrix. Accordingly, the heated material can likewise expand in the direction of the surface.

By locally introducing the heat with the ultrashort laser pulses, the material quickly cools after the introduction, because after the plurality of laser pulses were introduced, no more laser pulses heat the material and different, material-specific heat transport mechanisms, in particular thermal diffusion, transport the energy introduced away from the irradiation point. Due to the rapid cooling, for example the local density and consequently the hardness of the material can change. In this way, in particular the network structure of the material can be modified and a change in the fictive temperature of the glass can be brought about. In this way, in particular an approximately stress-free modification of the surface which has a changed hardness can be attained.

Due to the modification of the surface, the optical impression can also be changed, for example the method can cause the transmission and reflection properties of the material to change. For example, if light is transmitted through the glass, diffuse scattering can be achieved, or diffuse reflection if it is reflected at the material.

With the use of an elongated beam profile, for example a Bessel-type beam profile, it is also possible to harden the material from the surface into the volume of the material.

The laser beam can also be focused by means of an optical unit, and the focus region can be placed in the transparent material or on the surface of the transparent material.

This has the advantage that, by changing the location of the focus region and of the pulse energy of the ultrashort pulse laser, the material can be hardened and also the surface and parts of the volume of the material can be changed. With the selection of the focus position it is furthermore possible to determine whether primarily the surface or the volume of the material is intended to be hardened.

If the focus region lies in the transparent material, this means that the focus region lies below the surface. If the focus region lies on the surface, this means that the distance between the focus region and the surface is exactly zero.

Part of the laser energy is introduced into the transparent material by the focus lying in the transparent material or below its surface. In this way, the transparent material is heated and/or melted locally below the surface if the melting temperature of the material is exceeded for example by successive heat accumulation. The heat accumulation can be achieved by a burst of the laser or by introducing a plurality of individual laser pulses if the repetition rate is greater than the thermal diffusion time. As a result, the temperature increases from one laser pulse to the next. By heating using ultrashort laser pulses and subsequent rapid cooling, a change in the network structure, the density and a change in the hardness of the transparent material can be brought about, which is all the greater, the greater the heating is.

For example, transparent material that is heated in the focus of the laser beam can expand greatly, in particular expand radially. The merely slightly heated localities of the transparent material that are spaced apart from the focus, by contrast, expand only slightly. Consequently, a material stress running radially from the focus can be produced, which can result in particular in a changed material hardness.

If the material stress is small compared with the binding forces acting in the transparent material, the cooling process can cause the formation of a material modification that has a greater hardness than the non-heated regions. This can be the case in particular where the material stress expands into the non-irradiated material and there leads for example to a local compression of the material component parts.

If the focus lies exactly on the surface, the above descriptions apply analogously.

In order to be able to keep the processing constant over the entire region of the transparent material that is to be processed locally, the distance of the focus region from the surface of the transparent material is preferably kept automatically constant.

The temporal distance between the ultrashort laser pulses is preferably shorter than the thermal diffusion time of the transparent material. This applies both to the introduction of a plurality of individual laser pulses and also to the temporal distance between the laser pulses within a burst. Preferably, the distance between the at least two pulses is between 10 μs and 1 ps, with particular preference between 1 μs and 50 ps. The pulse overlap of the ultrashort laser pulses is generally greater than 1, in particular between 10 and 1000 pulses per laser spot. It is also possible for a plurality of ultrashort laser pulses in a pulse train to be emitted. The temporal distance of the pulse trains can be greater than 100 ns, in particular greater than 1 μs.

The laser pulses can be introduced into the material individually or in pulse trains. Pulse trains are a time-based group of laser pulses, for example of 10 laser pulses, within a first specific temporal distance. The resulting pulse sequence repeats after a second temporal distance. In particular, the pulse trains can also comprise what are known as bursts, wherein a specific average laser energy is divided over a multiplicity of pulses, and the processing process is thus subject to greater control.

If pulses arriving successively at a temporal distance are incident on the same location in the volume, it is possible to increase the temperature at that location. However, this assumes that the laser pulses introduced successively into the material heat the material more quickly than the temperature is given off again into the surrounding material regions and the environment by heat transport processes. This case is referred to as local heat accumulation. Due to the heat accumulation, it is possible to produce a greater heat in one point of the material than would be possible by a single laser pulse.

For example, for introducing a material modification, the temporal pulse distance between successive laser pulses can be shorter than the thermal diffusion time TD of the material. However, it is also possible to choose the temporal pulse distance to be longer than TD, for example T0<5*TD or T0<10 μs or T0>1 ps. The reason for this is that all that is required for heat accumulation is that a residual heat from the previous laser pulse is still in the material. The reason for this are, for example, incubation or non-linear (material) effects that influence the process limit.

In particular, the result of the heat accumulation can be that the material is melted locally.

The pulse overlap can be understood to be the number of laser pulses introduced per material modification. If the pulse overlap is 1, the material modification is introduced by one laser pulse. If, by contrast, pulse trains consisting of a plurality of laser pulses, for example 10 laser pulses, are emitted onto the material, the pulse overlap can be 10, for example. The pulse trains can also consist of significantly more laser pulses, however. In particular, the pulse overlap can lie between 10 and 1000.

If the material is shifted during processing relative to the incident laser beam, not all pulses will be incident on the same point in the material, but successive pulses will reach the material with a slight spatial offset. In this way it is possible that a material modification can then be produced for example on average also from a rational number of pulses. For example, a material modification of 1.5 pulses or 8.3 pulses can be introduced.

The laser beam and the transparent material can be shifted relative to one another by a feed.

For example, a feed apparatus, for example an XY stage, an XYZ stage or a scanner system, on which the transparent material for processing is mounted, can be moved along the X, Y and Z axes with a feed along the feed trajectory.

However, a feed apparatus can also be an electronically controllable acousto-optic deflector so as to quickly deflect the laser pulses and efficiently process a surface. In the case of an acousto-optic deflector, an AC voltage is used to generate at a piezo crystal in an optically adjacent material an acoustic wave that periodically modulates the refractive index of the optical material. The wave can propagate here through the optical material or be a standing wave. Owing to the periodic modulation of the refractive index, a diffraction grating for an incident laser beam is realized here.

An incident laser beam is thus diffracted at the diffraction grating and consequently deflected at least in part at an angle a to its original beam propagation direction. In particular, the laser beam is deflected by the angle offset in a direction perpendicular to the original propagation direction of the laser beam. The grating constant of the diffraction grating and thus the angle a here depend, among other things, on the wavelength or the periodicity of the standing grating vibration or on the frequency of the AC voltage applied. For example, a large angle offset for the first order of diffraction is attained by an acoustic wave having a small wavelength.

In particular, it is possible hereby to realize a quick beam deflection, wherein the laser beam can be positioned freely in the work field of the acousto-optic deflector unit at a rate of up to 1 MHz. A corresponding control apparatus for an acousto-optic deflector is therefore typically based on an FPGA (field programmable gate array) with quickly connected memories.

For example, the material can be moved with the feed, while the ultrashort pulse laser provides ultrashort laser pulses. In this way, the ultrashort laser pulses are introduced into the material at various points along the feed trajectory.

The feed apparatus can also rotate the material relative to the beam axis. In this way, laser pulses can be introduced into the material along round or curved feed trajectories, for example. In principle, rotational movements about for example all Euler angles are also possible, with the result that the rounded edges of a material can also be hardened by the laser under orthogonal beam incidence.

Feed allows the process speed to be increased. In combination with a suitable pulse overlap, it is furthermore possible to harden the material homogeneously.

The laser beam can sweep multiple times over at least one point of the transparent material.

This has the advantage that the material can be hardened successively and be adapted for example to a desired degree of hardness.

Sweep may mean that a plurality of laser pulses are emitted exactly onto the same point in the transparent material. The feed trajectory may, however, also be multiply shut down, wherein it is irrelevant where exactly on the trajectory the individual laser pulses are introduced. It is also possible that a plurality of pulses are introduced into the material successively at the same point during a single movement cycle along the feed trajectory. However, it is also possible that a plurality of laser pulses are introduced at the same points but during different movement cycles along the feed trajectory.

The laser beam can be split into a plurality of partial beams. This has the advantage that the feed rate of the laser can be increased and thus the process speed overall can also be increased.

A beam splitter optical unit can here include optics elements that split the laser beam and optics elements that steer and/or focus all resulting partial beams onto the transparent material in order to introduce a material modification. For example, using a 50/50 beam splitter, the first half of the energy of the laser pulse can be steered directly onto the transparent material. The second half of the energy can be steered onto the transparent material via a beam splitter. In this way, a laser pulse can produce a plurality of material modifications and thereby accelerate the method of locally hardening regions of the transparent material.

Accordingly, an apparatus for hardening a transparent material, in particular for locally hardening the surface of the transparent material, is proposed, comprising an ultrashort pulse laser and a focusing optical unit. According to the invention, the focusing optical unit focuses the laser beam of the ultrashort pulse laser into or onto the surface of the transparent material or above the surface of the transparent material, wherein the distance between the surface and the focus is less than 100 times, preferably less than 10 times, the characteristic length.

When the laser beam is introduced into the material, it can have a Gauss-type beam profile or the beam profile of a quasi non-diffractive beam, and/or the distance of the ultrashort laser pulses can be shorter than the thermal diffusion time of the transparent material, preferably between 10 μs and 1 ps, with particular preference between 1 μs and 50 ps, and/or the pulse overlap of the ultrashort laser pulses can be greater than 1, and/or a plurality of ultrashort laser pulses can be emitted in one pulse train and/or the temporal distance of the pulse trains can be greater than 100 ns, in particular greater than 1 μs.

A feed apparatus can move the laser beam and the transparent material relative to one another with a feed, and a distance sensor having a feedback unit can keep the distance of the focus of the laser relative to the surface of the transparent material constant.

For example, a distance sensor can maintain the distance between the point of incidence of the laser beam onto the material and any desired reference point. For example, reference points may be the points of a specified feed trajectory. A feedback unit can be, for example, a system that measures the deviation of the point of incidence from the reference point and compensates for the deviation accordingly. For example, if the transparent material is oriented obliquely, the height location of the material may need to be adapted along one feed direction, while no adaptation is necessary along a different feed direction.

This has the advantage that incorrect positioning of the material can be compensated for by the system.

The feed apparatus can be a laser scanner or an acousto-optic deflector, or a laser scanner or an acousto-optic deflector can move the laser beam in addition to a feed apparatus.

This makes it possible for the one laser beam to be moved in oscillating fashion over time over the material.

The feed apparatus can be, for example, an XYZ stage that can be provided with a piezo controller. Using the acousto-optic modulator, it is possible to deflect the laser beam in oscillating fashion and over time. It is also possible to shift the laser beam highly dynamically using a laser scanner, such as for example a galvano scanner or a resonance scanner.

A beam shaping optical unit can produce from a Gauss-type laser beam, before it is introduced into the material, a Gauss-Bessel-type or Bessel-type beam, and/or a beam splitter apparatus can split the laser beam into a plurality of partial beams.

The beam shaping optical unit can be in particular an axicon or a diffractive optical element that imposes on the incident laser beam a Gauss-Bessel-type or Bessel-type beam profile. The beam properties can be modified thereby in a particularly advantageous manner.

A beam splitter apparatus has the advantage that the process speed can be increased, as described above.

### DETAILED DESCRIPTION OF PREFERRED EXEMPLARY EMBODIMENTS

Preferred exemplary embodiments are described below with reference to the figures. In this case, elements that are the same, similar or have the same effect are provided with identical reference signs in the different figures, and a repeated description of these elements is dispensed with in some instances, in order to avoid redundancies.

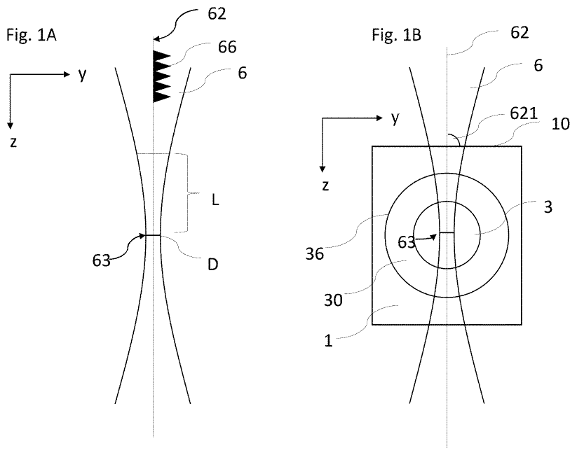

FIG. 1A schematically illustrates a focused Gauss-type laser beam 6 of an ultrashort pulse laser. However, the laser beam can also be a quasi non-diffractive beam (not shown). The ultrashort laser pulses 66 provided by the ultrashort pulse laser travel along the beam axis 62 and correspondingly form the laser beam 6. For example, the laser pulses 66 are emitted by the ultrashort pulse laser in pulse trains and/or bursts so that each pulse train comprises a plurality of ultrashort laser pulses 66.

Due to the focusing, the beam diameter of the laser beam 6 decreases until it has reached a minimum beam diameter D in the focus region. The minimum beam diameter D can be given in Gauss-type beam profiles by the beam waist, while in the case of Bessel-type beams it can be given by the full width at half maximum of the central intensity maximum, that is to say the distance to the point where the central intensity maximum perpendicular to the beam axis has lost 50% of its intensity.

The Gauss-type laser beam in FIG. 1A has in the focus 63 a minimum beam diameter, which increases along the beam axis starting from the focus 63, so that the size of the beam cross section increases. The distance over which the beam diameter doubles in the case of Gauss-type beams or the intensity of the central main maximum of a Bessel-type or Gauss-Bessel-type beam profile halves is understood to be the characteristic length L.

FIG. 1B schematically illustrates a transparent material 1, into which the laser beam 6 with the Gauss-type beam cross section is introduced. The beam axis 62 and the surface 10 of the transparent material enclose an angle of incidence 621, which is preferably 90°. For curved surfaces, the angle of incidence 621 is measured for example from the beam axis to the tangential plane of the surface. Here, the tangential plane is formed at the point in which the beam axis intersects the surface 10 of the transparent material 1.

In order to introduce a material modification into the transparent material 1, the laser beam of the ultrashort pulse laser 6 is focused at the transparent material 1. Due to the absorption of the laser pulses 66 of the laser beam 6, the transparent material 1 is heated locally. The local heating in combination with the subsequent cooling results here in a modification in the material structure, in particular in an increased material hardness. However, the local heating can also modify other physical properties of the material 1, for example increase or decrease the density to thereby locally build up stresses in the material.

This modification which has been introduced in the transparent material 1 is what is referred to as the material modification 3. Around the material modification 3 lies what is called a material modification region 30. In the material modification region 30, the material 1 transitions from the state that is present in the material modification 3 into its original state. The original state can be, for example, the unprocessed material state which is present for example in deeper material layers, or the state of the material present in the surrounding material regions. In particular, in FIG. 1B and all subsequent figures, the material modification is illustrated in an enlarged scale. The material modification 3 extends only in the region of the direct laser action, that is to say in the region of the beam cross section in the focus region.

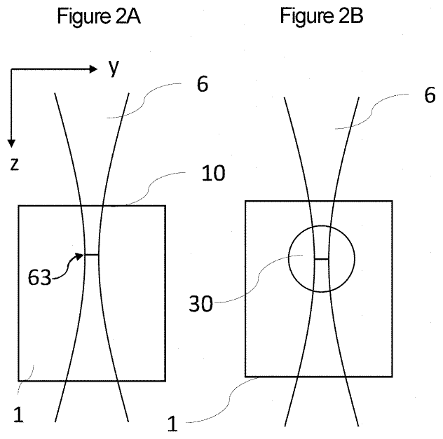

FIG. 2 schematically illustrates the hardening of the transparent material 1 if the focus 63 lies under the surface 10, that is in particular in the volume, of the transparent material 1.

FIG. 2A schematically shows how a laser beam 6 is focused into the material volume of the transparent material 1. If the focus 63 lies under the surface of the transparent material 1, a part of the laser energy provided by the ultrashort pulse laser is absorbed below the surface 10, as a result of which the material below the surface is heated particularly strongly. This heating can bring about for example a change in density, with the result that the material 1 expands particularly greatly where the focus 63 of the laser beam lies. The regions of the transparent material 1 lying around the focus are heated less or not at all due to the lower laser intensity outside the focus. As a result, the strongly heated material penetrates into the surrounding material regions, as a result of which the material 1 hardens at the shock front. With this method, the geometric structure of the surface 10 of the transparent material 1 can remain unchanged, and as a result only the hardness of the material 1 in the material modification 3 changes, as shown in FIG. 2B.

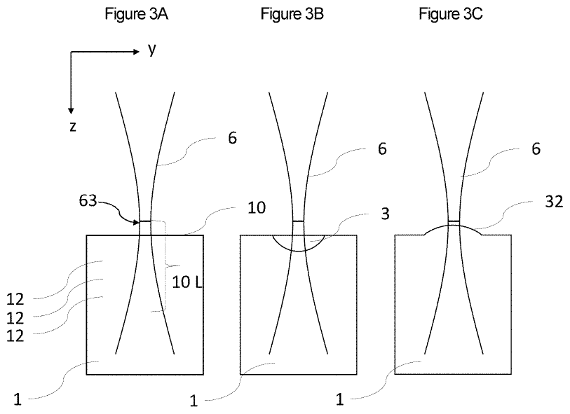

FIG. 3 schematically illustrates the method for hardening a transparent material 1 if the focus 63 of a Gauss-type laser beam lies above the surface 10. The distance between the focus 63 and the surface 10 can here in particular be less than 100 times the characteristic length L or less than 10 times the characteristic length L. In FIG. 3A, the distance between the focus 63 and the surface 10 is considerably smaller than 10 times the characteristic length 10L.

The intensity of the laser light is particularly great in the focus 63 and decreases for example by half along the beam axis 62 within the characteristic length L. Consequently, the surface 10 of the transparent material 1 is exposed to a considerably greater laser intensity than the layers 12 that lie deeper in the volume of the material 1. Consequently, considerably more energy of the laser pulses is absorbed at the surface 10 than in the deeper layers 12, as a result of which the transparent material 1 heats up more strongly at the surface 10 than in the deeper layers 12.

FIG. 3C illustrates that, owing to the focusing of the laser beam 6 into a position above the surface 10, only the lower part of the focus region that could bring about a material modification is introduced into the material 1.

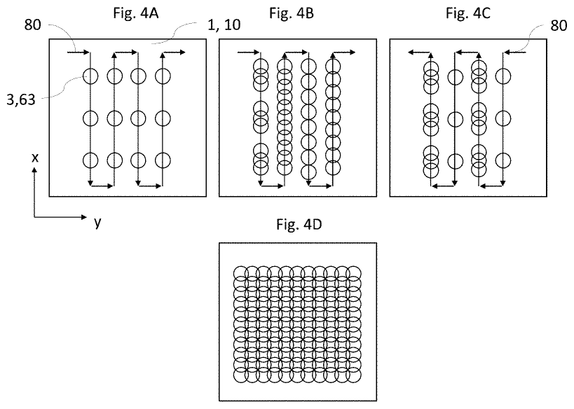

FIG. 4 illustrates that the laser beam and the transparent material 1 can be moved relative to one another along a feed trajectory 80, with the result that the material modifications 3 can be introduced into the material at different locations.

FIG. 4A shows the introduced material modifications 3 which were produced by an ultrashort pulse laser, wherein each material modification 3 was produced for example by a single laser pulse. However, it may also be the case that each material modification 3 was produced by a plurality of laser pulses that were emitted into the material 1 at the same point, for example also by way of a burst of laser pulses. For example a slight adaptation of the material hardness can be performed by way of such a distribution of material modifications.

FIG. 4B schematically illustrates how, with the same feed, the material modifications 3 can be introduced into the material 1 if a plurality of laser pulses 66 per pulse train can be emitted by the ultrashort pulse laser or the pulse rate is varied. For example, three laser pulses 66 can be arranged in one pulse train (first path from the left), with the result that the material modifications 3 produced by the laser pulses 66 partially overlap. It may also be the case that a pulse train comprises a significantly higher number of laser pulses 66 (second path from the left), so that the complete section of the feed trajectory is provided with overlapping material modifications 3. The material along this section is hardened for example particularly homogeneously along the trajectory. It may also be the case that the pulses are emitted such that adjacent material modifications 3 merely touch one another (third path from the left) or that the overlap of the material modifications 3 is only small.

It may also be the case that each material modification 3 was produced by a plurality of laser pulses 66 that were emitted into the material 1 at the same point, so that the pulses and the respective focus regions, given by the beam cross section in the focus, overlap.

In particular, FIG. 4B can also be understood in a way such that the focus regions 63 of the laser pulses overlap. For example, it is possible for a material modification that hardens the material 1 to occur in the overlapping regions of the laser pulses that have been introduced.

It is in particular also possible owing to the distribution of the material modifications to set a hardness profile or a hardness gradient in the material.

FIG. 4C shows, proceeding from FIG. 4A, that an overlap of the material modifications 3 or of the focus regions 63 of the laser pulses can also occur during a further movement cycle over the material 1 or along the feed trajectory 80. For this, the direction of the feed trajectory is reversed. The laser pulses 66 or material modification 3 can be introduced with an overlap or in addition to the laser pulses 66 (solid circles) or material modifications that have already been introduced.

FIG. 4D illustrates that with a suitable scanning geometry of the laser, for example homogeneous hardening of a region of the surface or of the entire surface can be carried out. For this purpose, the focus regions, given by the beam cross sections, or adjacent material modifications 3 must overlap with substantially the nearest neighbors. The regions can comprise, for example, edge regions or regions that are exposed to particularly high loads. The hardening material modifications can be introduced in particular at different depths in the volume.

Overall, the entire process of local hardening can be performed in a single movement cycle, wherein during the movement cycle the focus location of the focused laser beam relative to the surface 10 of the material remains the same.

However, it is preferred to achieve the hardening by way of a plurality of movement cycles so as to reduce stresses that may occur during the process in the overlap region. In this case, the focus location of the focused laser beam can furthermore be changed but preferably at most by the amount of the characteristic length.

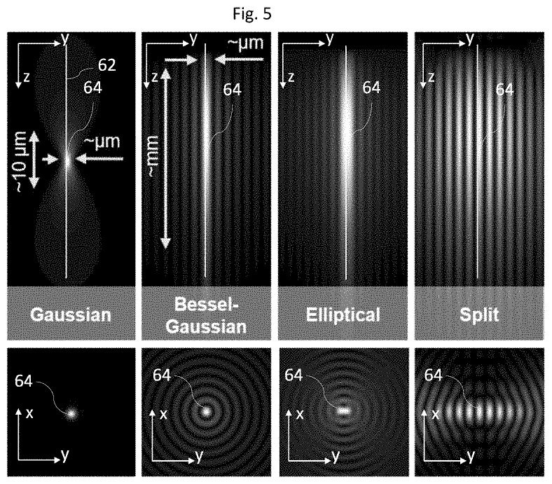

FIG. 5 illustrates various examples of beam profiles (in the YZ plane) with the associated beam cross sections (in the XY plane). It shows that a radial-symmetric Gaussian beam cross section has a significantly smaller extent along the beam axis 62, that is to say a significantly smaller characteristic length L, than for example a Bessel-Gauss beam or an elliptically shaped beam. The given scale in the figures should be taken into consideration in this respect. As a result, it is possible to utilize a large longitudinal extent of the focus region along the beam axis 62 when using a Bessel-type beam cross section. In particular, the beam profile used can thus be reflected in the focus position tolerance, with the result that the method becomes insensitive to local surface roughnesses.

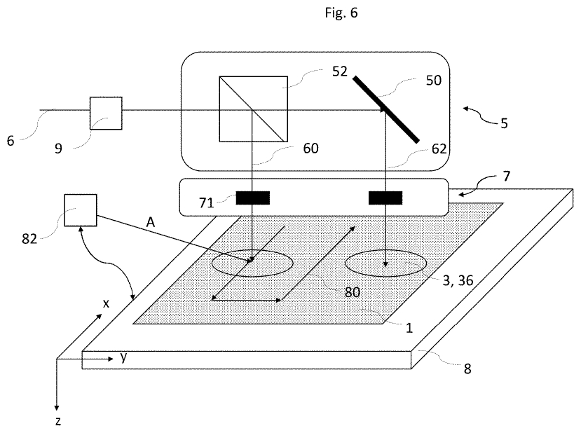

FIG. 6 shows a setup for carrying out the method. The Gauss-type laser beam 6 of an ultrashort pulse laser is reshaped by an optional beam shaping optical unit 9 into a quasi non-diffractive beam and is then steered onto the transparent material 1 by a likewise optional beam splitter optical unit 5. The beam splitter optical unit 5 consists for example of a beam splitter 52 and a mirror 50.

In the present example, the beam of the laser 6 is split into a first partial beam 60 and a second partial beam 62 using the beam splitter 52. The first partial beam 60 is steered directly in the direction of the transparent material 1 by way of the beam splitter 52. The second partial beam passes through the beam splitter 52 and is then steered in the direction of the transparent material 1 by the mirror 50. Both partial beams are focused onto or into the transparent material 1 by a focusing unit 7. Here, the focusing unit 7 can include focusing optical units 71 for each partial beam or include only one focusing optical unit 71 for all partial beams. In the transparent material, the first partial beam 60 and the second partial beam 62 cause material modifications 3 that lead to hardening of the material. In particular, the beam profile of the laser beam is not changed by the beam splitter optical unit 5. Consequently, material modifications 3 of the same shape are produced by the two partial beams in the transparent material 1. It is thereby possible that the feed of the feed apparatus 8 of the laser light relative to the transparent material 1 can be increased, for example can be doubled, because now a plurality of modifications 3 per laser pulse are introduced into the material 1.

In order to compensate for unevennesses on the surface 10 during the feed motion, a distance sensor can measure the distance A between the laser focus 63 and a reference point. The feed apparatus 8 can then compensate the unevenness via a feedback unit 82 by adapting the alignment of the material.

Insofar as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Transparent material

10 Surface

12 Deeper layer

3 Material modification

30 Material modification region

32 Material curvature

34 Material crater

36 Material modification cross section

5 Beam splitter optical unit

50 Mirror

52 Beam splitter

6 Laser beam

62 Beam axis

621 Angle of incidence

63 Focus

64 Central intensity maximum

66 Laser pulse

600 First laser beam half

602 Second laser beam half

7 Focusing unit

71 Focusing optical units

8 Feed apparatus

80 Feed trajectory

82 Distance and feedback unit

9 Beam shaping optical unit

L Characteristic length

D Diameter

A Distance

1. A method for hardening a transparent material comprising:
introducing a material modification to the transparent material using a laser beam of ultrashort laser pulses of an ultrashort pulse laser so as to harden at least a portion of the transparent material.

2. The method as claimed in claim 1, wherein the transparent material is a glass or a polymer or a ceramic.

3. The method as claimed in claim 1, further comprising focusing the laser beam using an optical unit so as to dispose a focus region outside of the transparent material at a distance of less than 100 times a characteristic length from a surface of the transparent material.

4. The method as claimed in claim 1, further comprising focusing the laser beamusing an optical unit so as to dispose a focus region in the transparent material or on a surface of the transparent material.

5. The method as claimed in claim 3, wherein the distance of the focus region relative to the surface of the transparent material is automatically kept constant.

6. The method as claimed in claim 1, wherein the laser beam has a Gauss-type beam profile or a beam profile of a quasi non-diffractive beam.

7. The method as claimed in claim 1, wherein
a distance between the ultrashort laser pulses is shorter than a thermal diffusion time of the transparent material, and/or
a pulse overlap of the ultrashort laser pulses is greater than 1, and/or
a plurality of ultrashort laser pulses are emitted in a first pulse train, wherein a temporal distance of the pulse trains is greater than 100 ns.

8. The method as claimed in claim 1, further comprising shifting the laser beam and the transparent material relative to one another using a feed.

9. The method as claimed in claim 1, wherein the laser beam sweeps multiple times over at least one position of the transparent material.

10. The method as claimed in claim 1, further comprising splitting the laser beam into a plurality of laser beams, before the introducing of the material modification.

11. The method as claimed in claim 1, wherein the material is prestressed by being chemically or thermally hardened prior to introducing the material modification.

12. An apparatus for hardening a transparent material, comprising:
an ultrashort pulse laser;
a focusing optical unit configured to focus a laser beam of the ultrashort pulse laser into or onto a surface of the transparent material, or to focus the laser beam above the surface of the transparent material,
wherein a distance between the surface and the focus region is less than 100 times a characteristic length in order to harden at least a portion of the transparent material.

13. The apparatus as claimed in claim 12, wherein
the laser beam has, when it is introduced into the material, a Gauss-type beam profile or a beam profile of a quasi non-diffractive beam, and/or
a distance between the ultrashort laser pulses is shorter than a thermal diffusion time of the transparent material, and/or
a pulse overlap of the ultrashort laser pulses is greater than 1, and/or
a plurality of ultrashort laser pulses are emitted in one pulse train having a temporal distance greater than 100 ns.

14. The apparatus as claimed in claim 12, further comprising:
a feed apparatus configured to provide a relative movement between the laser beam and the transparent material, and/or
a distance sensor having a feedback unit configured to keep the distance of the focus region of the laser beam relative to the surface of the transparent material constant.

15. The apparatus as claimed in claim 14, wherein the feed apparatus is a laser scanner or an acousto-optic deflector and is configured to move the laser beam independently of the feed apparatus.

16. The apparatus as claimed in any of claims 12, further comprising a beam shaping optical unit configured to produce from a Gauss-type laser beam, before it is introduced into the material, a quasi non-diffractive beam, and/or a beam splitter apparatus configured to split the laser beam into a plurality of partial beams.
